(19) United States
(12) Patent Application Publication
(10) Pub. No.: US 2014/0097282 A1
(43) Pub. Date: Apr. 10, 2014

(54) GYRATORY CRUSHER WITH PISTON

(71) Applicant: SANDVIK INTELLECTUAL PROPERTY AB, SANDVIKEN (SE)

(72) Inventors: Bengt-Arne Eriksson, Svedala (SE); Martin Nilsson, Vellinge (SE); Niklas Aberg, Sodra Sandby (SE)

(73) Assignee: SANDVIK INTELLECTUAL PROPERTY AB, SANDVIKEN (SE)

(21) Appl. No.: 14/124,259

(22) PCT Filed: May 29, 2012
(86) PCT No.: PCT/EP2012/059964

§ 371 Date: Dec. 17, 2013

(30) Foreign Application Priority Data
Jun. 7, 2011 (EP) 11168975.8

(51) Int. Cl. B02C 2/04

(52) U.S. Cl. CPC B02C 2/047
USPC 241/215; 241/207; 241/286

(57) ABSTRACT

A cylindrical, hollow piston for a gyratory crusher includes a piston wall, a piston top and a piston bottom. The piston wall includes at least one opening leading into an inner chamber of the hollow piston. The piston wall has an outer sliding surface and an inner chamber surface.

### TECHNICAL FIELD OF THE INVENTION

The present invention relates to a gyratory crusher comprising a piston for a gyratory crusher; which piston is cylindrical and hollow and comprises a piston wall, a piston top and a piston bottom, which piston wall comprises at least one opening leading into an inner chamber of the hollow piston, which piston wall comprises an outer sliding surface and an inner chamber surface.

### BACKGROUND ART

Upon fine crushing of hard material, e.g. stone blocks or ore blocks, material is crushed that has an initial size of approx. 100 mm or less to a size of typically approx. 0-25 mm. Crushing, e.g. fine crushing, is frequently carried out by means of a gyratory crusher. Known crushers have an outer shell that is mounted in a stand. An inner shell is fastened on a crushing head. The inner and outer shells are usually cast in manganese steel, which is strain hardening, i.e. the steel gets an increased hardness when it is exposed to mechanical action.

A known gyratory crusher has a frame, comprising an upper frame portion and a lower frame portion. A vertical central shaft is fixedly attached to the lower frame portion via support by a cylinder-piston assembly comprising a thrust bearing arranged on a piston of a hydraulic cylinder disposed in the frame. An eccentric is rotatably arranged about the central shaft, i.e. mounted on the shaft, which excenter is adapted to rotate about said shaft by means of a driving device for crushing the material between the inner and outer shells in a known way. The piston is in general hollow and has circular walls having a uniform thickness, which gives a cylindrical space in the centre of the piston.

However, about 125 years have passed since the first gyratory crusher was created, and used almost everywhere in the world practice, but its basic design has not changed. Hence, if the crushing force is to be increased, e.g. by 20%, to improve the crushing capacity, crusher designers have conventionally only “upscaled” the crusher, i.e. most of the crusher dimensions of a smaller crusher has been increased in an enlarged scale being proportional to the increased crushing force as shown in FIGS. 1 to 6 to be able to carry and withstand the increased crushing force. This enlargement of known crushers increases both their own/tare weight and their outer dimensions in proportion to the increased crushing force.

Such an increase of the crushing force is in principle directly transmitted from the crushing head on the vertical central shaft downwards via the thrust bearing, which is lubricated be means of fluid forming lubricating film between the shaft and the piston, to the piston of the hydraulic cylinder disposed below the end of the shaft, which piston then is subjected to deformation. This deformation of a conventional piston leads to a corresponding deformation or at least a temporary change of the shape of the thrust bearing, i.e. the known thrust bearing comprises three horizontal bearing plates, which then also are deformed or at least bent resulting in a worsening of the lubricating between these plates and ultimately increase the wear and heat generation therebetween.

As mentioned above, the crushing forces acting on the piston leads to problems of deformation of the piston. The crushing forces and the deformation may cause weakening of the piston resulting in rupture and breakage of the piston.

### SUMMARY OF THE INVENTION

It is an object of the invention to provide a gyratory crusher and a piston, which solve, or at least lessen, the problems mentioned above.

It is an object of the invention to provide an inventive piston enabling the use of the same thrust bearing as in an old crusher while still being able to withstand an increased crushing force.

It is an object of the invention to provide an inventive piston being able to withstand a higher crushing force without increasing the dimensions, i.e. at least the outer dimensions of the piston.

Another object of the invention is to provide a gyratory crusher with an inventive piston that reduces the number of crusher parts and dimensions that have to be enlarged for carrying the increased crushing force and stresses associated therewith.

Yet another object of the invention is to provide a gyratory crusher with an inventive piston that reduces its own weight compared to the conventional way of only enlarging most parts of the crusher for carrying the increased crushing force and stresses associated therewith, i.e. the inventive crusher has an optimized tare weight and load carrying ratio for the piston compared to known pistons in prior art crushers.

These objects are achieved by means of a piston and a gyratory crusher as claimed in the associated independent claims, preferred variants thereof being defined in the associated dependent claims.

In particular, the piston according to the independent claim 1 makes it possible to increase the crushing force without increasing the dimension of the thrust bearing. This means that it is possible to use the same thrust bearing as in an old crusher despite increasing the crushing force.

Further, the piston according to the independent claim 1 enables increased crushing forces without increasing the dimensions, i.e. at least the outer dimensions, of the piston.

The gyratory crusher with a piston according to the independent claim 1 also makes it possible to increase crushing force by only enlarging the dimensions of one part of the crusher, i.e. the inner portions of the piston, instead of enlarging more parts of the crusher, e.g. the thrust bearing and its associated parts, wherefore the work in designing and manufacturing the piston is simplified and requires less effort in man hours compared to the conventional way of enlarging most parts of the thrust bearing, i.e. in view of the whole chain of design and manufacture.

In addition, the gyratory crusher with a piston according to the independent claim 1 has an increased ability to withstand crushing forces in relation to its weight compared to conventional crushers with known pistons. The piston according to the independent claim 1 achieves a minimum weight increase of the piston in relation to the improved ability of the piston, and thereby also of the crusher, to withstand increased crushing forces.

In some embodiments, the at least one supporting structure is connected with the inner chamber surface of the piston wall. Thereby, the piston wall is reinforced. In addition, the supporting member together with the piston wall supports the piston top and thereby strengthens the piston.

In some embodiments, the at least one supporting element protrudes from the piston wall and inwards. Thereby, the piston wall is reinforced strengthening the piston.

In some embodiments, the at least one supporting element is in the form of a pillar integrated with the piston wall. Thereby, a robust construction giving an increased strength is obtained. Further, the integration of the pillar with the piston wall facilitates the manufacturing/casting of the piston.

In some embodiments, the at least one supporting structure and the piston wall are made in one piece of material. Hence, the manufacturing, i.e. the casting of the piston is simplified.

In some embodiments, the at least one supporting structure, the piston top and the piston bottom are made in one piece of material. Thereby, the manufacturing/casting of the piston is further simplified.

In some embodiments, the at least one supporting structure, the piston top, the piston bottom and the piston wall are made in one piece of material. Similarly, the manufacturing/casting of the piston is yet further simplified.

In some embodiments, the at least one supporting structure protrudes radially towards the centre of the hollow supporting piston. Thereby, the ability to withstand an increased crushing force is increased further. In particular the ability to withstand an increased crushing force is increased when this is combined with that the supporting element is connected with the inner chamber surface of the piston wall and/or protrudes from the piston wall and inwards, since the supporting structure supports the piston top from the piston wall to a distance that is as far from the piston wall as possible in relation to the extension from the wall of the supporting structure.

In some embodiments, the at least one supporting structure is arranged between the piston wall and a centre space in the inner chamber of the piston, which centre space acts as a clearance space. Thereby, an empty space is present in the centre of the piston. This may facilitate the housing of auxiliary equipment.

In some embodiments having an empty space in the centre of the piston, the centre space of the piston is adapted to accommodate a measuring device. Since the centre space of the piston is adapted for accommodating a measuring device, measurements may be performed in the centre of the piston. Because of the adaption, measuring devices may easily be introduced and mounted into or dismounted from the hollow piston.

In an embodiment, the top element is turnably locked with the piston top. Thereby, the piston and the top element do not rotate in relation to each other.

In some embodiments, the top element is part of a thrust bearing. Hence, the piston is operatively connected to the lower part of the thrust bearing, i.e. the top element, which does not rotate in relation to the piston.

In some embodiments, the hollow supporting piston comprises at least two supporting elements connecting the piston top and the piston bottom. The presence of at least two supporting elements increases the strength of the piston further. Alternatively to the increased strength, the presence of at least two supporting elements may reduce the size of each supporting element necessary to achieve a specific strength. Naturally, these two alternatives may be combined, i.e. by the presence of at least two supporting elements an increased strength can be achieved simultaneously as the size of each supporting element is reduced, but the effect of increased strength and reduced size, respectively, are not as significant as if only one alternative is chosen.

In some embodiments, the hollow supporting piston comprises at least three supporting elements connecting the piston top and the piston bottom. The presence of at least three supporting elements further increases the strength of the piston and the possibility to reduce the size of each supporting element necessary to achieve a specific strength as described above.

One effect of the invention is that the crushing forces can be increased without having to enlarge all or at least most of the parts of the crusher. It has been found that by means of the invention, the crushing forces can be increased without having to increase the outer dimensions of the piston.

### BRIEF DESCRIPTION OF THE DRAWINGS

The invention will be described in more detail with reference to the appended drawings, which show examples of presently preferred embodiments of the invention.

FIGS. 1 to 6 show prior art crushers that in the hitherto conventional way in response to increasing crusher capacities and crushing forces have been developed by “upscaling”, i.e. enlarging the dimensions of the whole crusher in proportion to the increased crusher force stepwise from the smallest crusher in FIG. 1 to the largest crusher in FIG. 6,

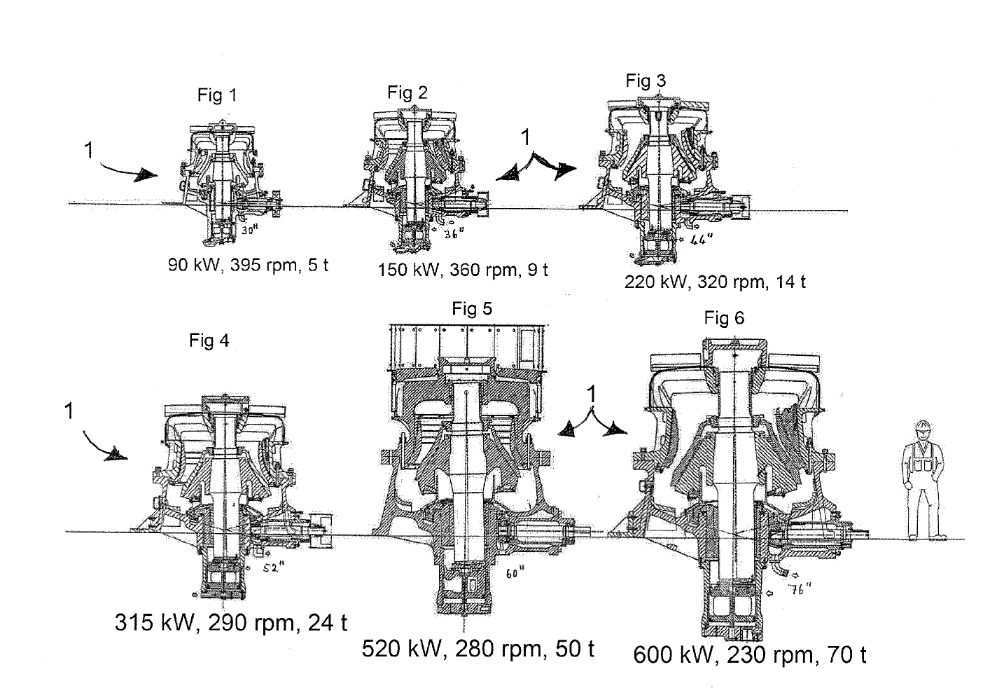

FIG. 7 is a perspective view of the gyratory crusher according to the invention with a piston assembly including a piston, which partly is cut out for showing the inner parts of the crusher.

FIG. 8 is a cross sectional view of the cylinder-piston assembly in FIG. 7 with a piston.

FIG. 9 is a perspective view of the cylinder-piston assembly in FIGS. 7 and 8 with a piston but with an incomplete thrust bearing, which partly is cut out for showing the inner parts and surfaces.

FIG. 10 is a perspective view of the cylinder-piston assembly in FIG. 9, which partly is cut out for showing the inner parts and which partly is an exploded view.

FIG. 11 is a perspective view of the piston in FIGS. 7-10, which partly is cut out for showing the inner of the piston.

FIG. 12 is a perspective view of the piston in FIGS. 7-11, which partly is cut out for showing the inside of the piston.

### DETAILED DESCRIPTION OF THE INVENTION

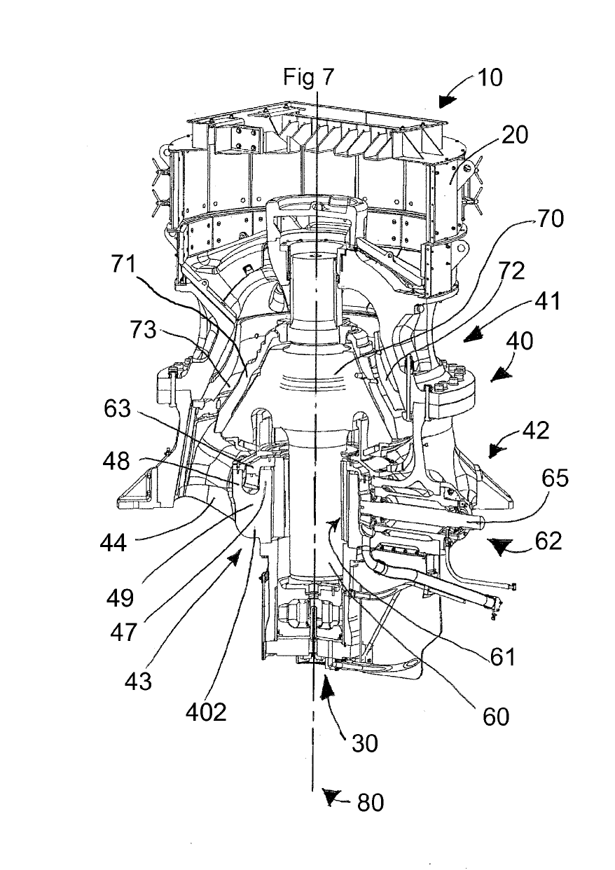

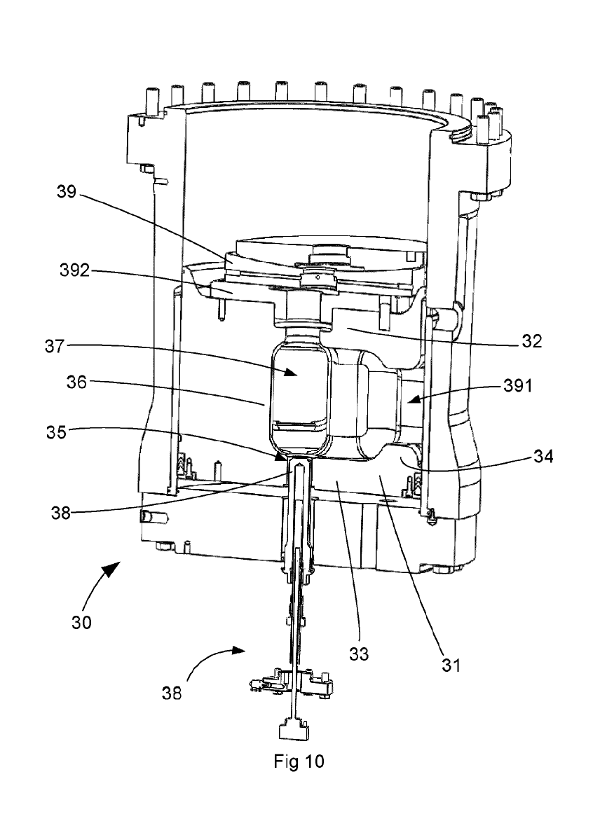

A piston and a crusher will now be described with references made to FIGS. 7-12. The crusher 10 (shown in FIG. 7) has a frame 40, comprising an upper frame portion 41 and a lower frame portion 42 comprising a hub 43. A vertical central shaft 60 is supported by the lower frame portion 42 of the frame 40, via a spherical support in a cylinder-piston assembly 30 (see FIGS. 7-10) comprising a thrust bearing 39 arranged on a piston 31 (see FIGS. 7-12) arranged in a hydraulic cylinder disposed in the frame 40. An eccentric 61 is rotatably arranged about the central shaft 60, i.e. mounted on the shaft, which excenter is adapted to rotate about said shaft. A crushing head 70 is mounted about the central shaft, and thus indirectly in the eccentric 61. A drive shaft is arranged to cause the eccentric 61 to rotate about the central shaft 60 by means of a conical gear wheel engaging with a gear rim connected to the eccentric. The eccentric comprises a hole through which the shaft is arranged, which hole is displaced in relation to a centre axis 80 of the hub 43 and is slightly inclined relative to the vertical plane to accommodate the tilting shaft, which is per se known in the art. Because of the displacement of the hole of the eccentric 61 and the shaft, the crushing head 70 will also be slightly inclined relative to the vertical plane.

A first crushing shell 71 is fixedly mounted on the crushing head 70 being fixedly mounted to the shaft 60. A second crushing shell 72 is fixedly mounted on the upper frame portion 41. Between the two crushing shells 71, 72 a crushing gap 73 is formed, the width of which, in axial section as illustrated in FIG. 7, decreases in the downward direction. When the drive shaft, during operation of the crusher 10, rotates the eccentric 61, the crushing head 70 will execute a gyrating movement that drives the first crushing shell being an internal cone. A material to be crushed is introduced in the crushing gap 73 and is crushed between the first crushing shell 71 and the second crushing shell 72 as a result of the gyrating movement of the crushing head 70, during which movement the two crushing shells alternately approach and move away from one another in a gyratory pendulum motion, i.e. a motion during which the inner first crushing shell 71 and the outer second crushing shell 72 approach each other along a rotary generatrix and retreat from each other along another diametrically opposite generatrix. Furthermore, the crushing head 70, and the first crushing shell 71 mounted thereon, will be in rolling engagement with said second crushing shell 72 by way of the material to be crushed. This rolling engagement causes first crushing shell, the crushing head and the shaft to rotate slowly together in a direction of rotation that is substantially opposite to the direction of rotation of the eccentric 61 during crushing.

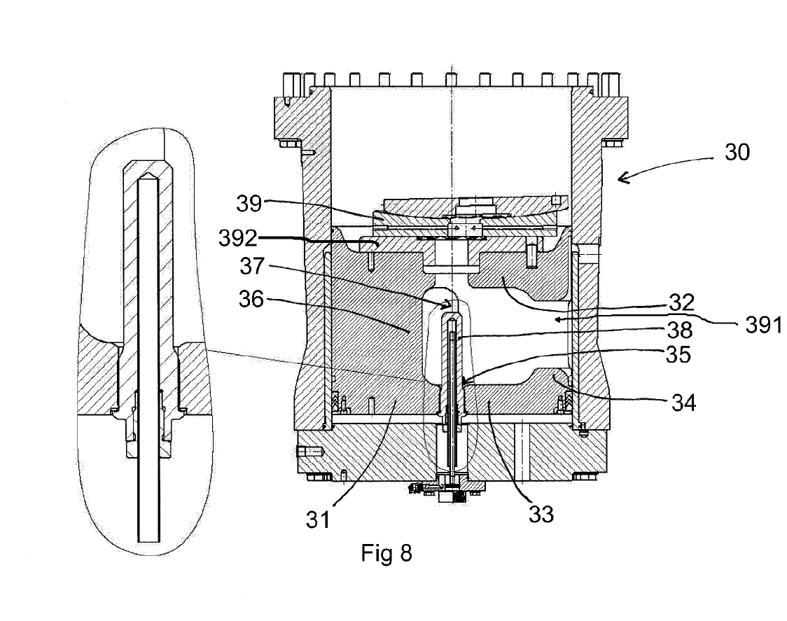

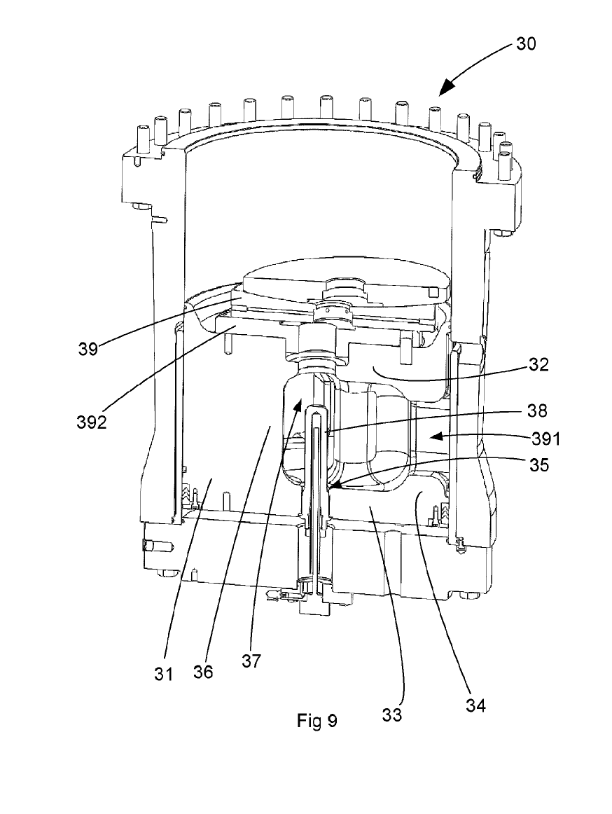

The thrust bearing 39 (shown in FIGS. 8 and 9) comprises a first bearing plate being attached to the vertical shaft 60, a second bearing plate in the form of a top element 392 being attached to the piston 31 arranged below the vertical shaft 60, and a third bearing plate being slideably and rotatably arranged between the first and second bearing plates. The first and second bearing plates are generally made of a bearing metal, such as bronze, and the third bearing plate is often made of steel. The piston 31 forms together with the cylinder a hydraulic cylinder-piston assembly 30 by means of which the vertical position of the vertical shaft 60 can be displaced for setting a desired crushing gap 73 between the first crushing shell 71 and the second crushing shell 72 in a known way. The thrust bearing 39 is lubricated by means of fluid forming a lubricating film between the bearing plates.

The piston 31 is hollow and supports the crushing head 70 and the shaft 60 in the vertical direction. The piston 31 is cylindrical and comprises a piston top 32, a piston bottom 33 and a circular piston wall 34 as shown in FIGS. 8 and 9. The piston 31 is hollow and comprises at least one opening 391 in its piston wall 34 leading into an inner chamber of the piston.

The piston 31 carries load from the shaft 60 and the load is especially heavy on the piston top 32, but also the piston wall 34 is exposed to a substantial load. The load on the supporting piston 31 is derived from the shaft 60 and the parts attached to the shaft 60, such as the crushing head 70 and the first crushing shell 71, as well as the crushing force as described above.

The piston 31 is reinforced by at least one supporting structure 36 for supporting the piston top 32 as shown in FIGS. 8-12. The supporting structure 36 may be made in different forms and may comprise a varying number of portions and/or elements constituting the structure. The supporting structure comprises at least two supporting elements 36 for supporting the piston top 32. The supporting elements 36 of the supporting structure protrude inwards from the piston wall 34 and strengthen the piston top 32 as well as the piston wall 34. The supporting elements 36 extend vertically from the piston bottom 33 to the piston top 32. Thereby, the supporting elements 36 are supported by the piston bottom 33 and consequently also the piston top 32 is supported by the piston bottom 33, which increases the ability to withstand crushing forces. The supporting elements 36 form pillars integrated with the piston wall 34.

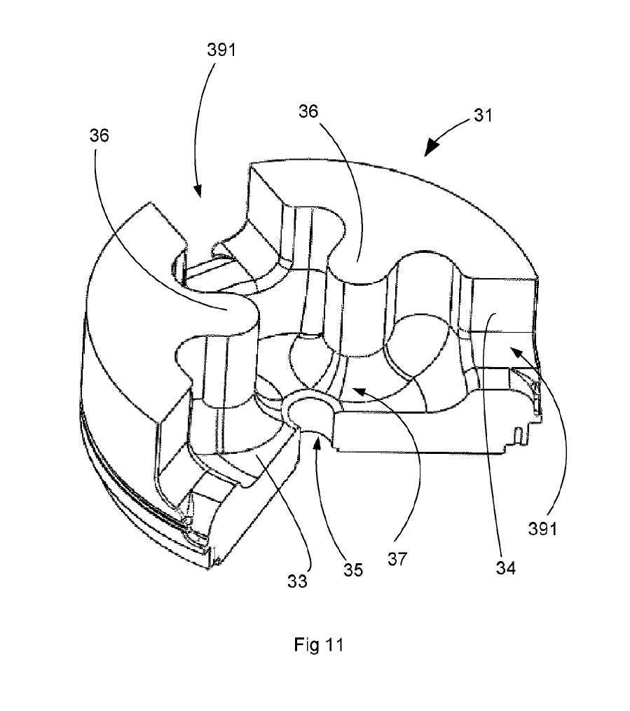

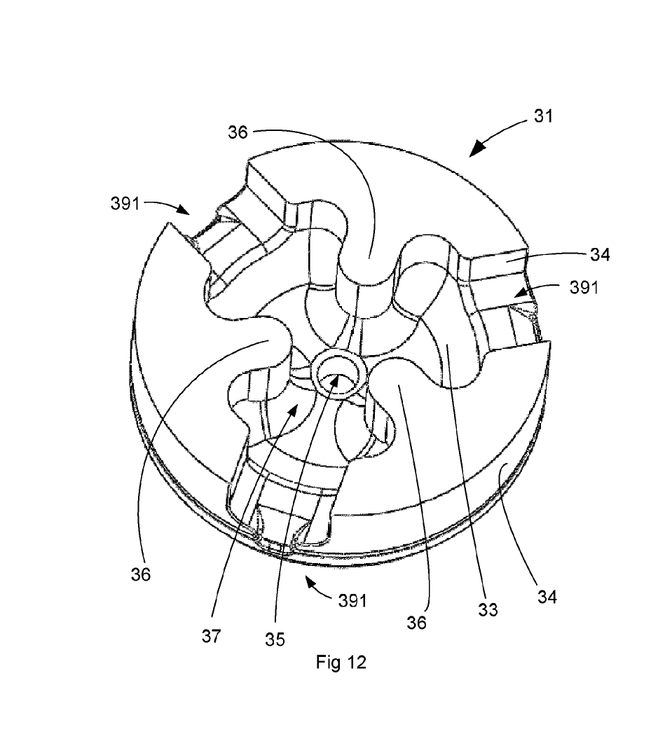

The supporting structure 36 may be a plurality of supporting elements 36 supporting the piston top 32 (see FIGS. 11 and 12), which increases the strength of the piston 31 further. In FIG. 12 three supporting elements are shown. The increase in strength when a plurality of supporting elements 36 is present is significant. The presence of a plurality of supporting elements 36 reduces the necessary size of each supporting element 36 in order to achieve a specific increase of the strength of the piston 31. The presence of a plurality of supporting elements 36 reduces the necessary total volume of the supporting elements 36 in order to achieve a specific increase of strength of the piston 31. Thereby, the presence of a plurality of supporting elements 36 decreases the weight of the piston 31 and the consumption of material for manufacturing the piston 31.

The supporting elements 36 have a wave form. Each supporting element 36 is in the form of a wave with uniform amplitude along its extension from the piston bottom 33 to the piston top 32. The supporting elements 36 form a pattern of waves along the inner circumference of the piston wall 34.

In the centre of the piston 31, a clearance space is arranged as shown in FIGS. 8-12. Thus, the supporting elements do not protrude all the way to the centre of the piston 31. Instead the supporting elements 36 protrude to a center space 37 of the piston 31. The centre space 37 is a free/empty space in the center of the piston 31 (see centre axis 80 of crusher/piston in FIG. 7), which has a fictitious/imaginary circular wall forming a cylinder parallel to the piston wall 34. In the centre of the piston bottom 33 a piston bottom opening 35 is arranged. A measuring device 38 is arranged in the bottom opening 35 and protrudes into the centre space 37 of the piston 31 (see FIGS. 8-11).

The supporting elements 36, which protrude from the piston wall 34 and inwards and which support the piston top 32 of the piston 31, reinforce the piston. The reinforcement is considerable for the piston top 32 and the piston wall 34, in particular for the piston top 32.

The supporting elements 36 bring increased strength to the supporting piston 31 with a minimal increase in weight and consumption of material. Thereby, increased strength is obtained at low increase of costs for both transportation and material.

The piston 31 may comprise further apertures in the piston wall 34, piston top 32 and/or piston bottom 33 for example to facilitate lubricating of the thrust bearing. In FIGS. 8-12 the piston wall 34 comprises apertures and in FIGS. 8-10 an aperture is present in the piston top 32.

The piston 31 may be casted. Preferably, the piston 31 is casted in one piece. Moreover, the supporting structure 36 and the piston wall 34 may be made in one piece of material. Furthermore, the supporting structure 36, the piston top 32 and the piston bottom 33 may be made in one piece of material. Similarly, the supporting structure 36, the piston top 32, the piston bottom 33 and the piston wall 34 may be made in one piece of material.

In short, the invention can be described as a crusher 10 comprising a crushing head 70, which is arranged rotatably about a substantially vertical shaft 60, and on which a first crushing shell 71 is mounted; a crusher frame 40, on which a second crushing shell 72 is mounted, which second crushing shell 72, together with the first crushing shell 71, delimits a crushing gap 73; a cylinder-piston assembly 30 comprising the cylindrical hollow supporting piston 31, which supports the crushing head 70 and the shaft in the vertical direction; an eccentric 61, which is arranged rotatably about the shaft; and a driving device 62, which is arranged to rotate said eccentric in order to cause the crushing head 70 to execute a gyratory pendulum movement for crushing of material introduced into the crushing gap 73; the supporting piston 31 comprising a wall 34, a top 32 and a bottom 33, wherein the supporting piston comprises at least one supporting structure 36 connecting the top 32 and bottom 33.

The gyratory crusher 10 shown in FIG. 7 is specifically designed for increased strength. The piston 31 (see FIGS. 7-12) is specifically designed for withstanding increased crushing forces in relation to its outer dimensions, i.e. the outer dimensions of the piston are maintained.

Prior art pistons have an inner upstanding integrated cylinder being a part of the casted piston, i.e. this upstanding integrated cylinder is fixedly arranged in the centre of the piston and protrudes with the longer end inwards of the piston from the piston bottom towards the piston top and protrudes with a shorter end downwards from the piston bottom and externally beyond the piston bottom. The cylinder protrudes a distance being long enough to enable providing a longitudinal bottom hole with its bottom facing upwards towards the piston top and an opening facing downwards. This prior art integrated and fixed cylinder also has a separate inner tube being introduced into the inner hole of the cylinder to form an inner surface therein for a stationary inductive gauge to run through when the piston and its integrated inner cylinder and inner surface tube moves up and down in a known way. This prior art inner tube is fastened by gluing the outer surface of the tube onto the inner surface of the cylinder hole.

The piston 31 according to the invention comprises the measuring device 38 being detachably attached to the piston bottom 33. This measuring device 38 replaces the integrated prior art cylinder and its associated equipment by enabling new and inventive removable mounting and sealing by means of a separate cylinder adapted for detachable fastening to the piston bottom opening 35 enabling easier dismounting. The measuring device 38 also uses sealings in the form of circular gaskets made of rubber for sealing the detachable cylinder against the piston bottom and a lower outer part of the measuring device against a bottom opening of the cylinder-assembly. The lower outer part of the measuring device also enables draining of oil in the space between the piston bottom 33 and the bottom opening for the cylinder meaning that oil spill is to a large extent reduced when disassembling the measuring device 38. The measuring device 38 also has an inner tube being removably attached to its detachable cylinder, through which inner tube the inductive gauge runs. This detachably arranged inner tube also simplifies disassembly and assembly of the whole measuring device 38, but, in particular, simplifies the disassembly of the removably attached inner tube that in prior art was fixedly attached by gluing. Moreover, by eliminating the prior art solution with an integrated cylinder inside the inner chamber of the piston made by casting requiring after-treatment as the casted metal in the integrated prior art cylinder has a low quality, i.e. a high content of pores due to the high temperatures at that centre area during casting in prior art, the manufacture of the new and inventive piston 31 is simplified by only requiring a bottom hole 35 instead of the prior art integrated and fixed inner cylinder.

10 gyratory crusher

30 cylinder-piston assembly

31 piston

32 piston top

33 piston bottom

34 piston wall

35 piston bottom opening

36 supporting structure/element

37 centre space of piston

38 measuring device

39 thrust bearing

391 piston wall opening

392 top element

40 crusher frame

41 upper crusher frame portion

42 lower crusher frame portion

43 crusher frame hub

60 shaft

61 eccentric

62 driving device

70 crushing head

71 first crushing shell

72 second crushing shell

73 crushing gap

80 centre axis of crusher and piston

1. A piston for a gyratory crusher, which piston is cylindrical and hollow, comprising:
a piston wall;
a piston top;
a piston bottom, the piston wall including at least one opening leading into an inner chamber of the hollow piston, an outer sliding surface and an inner chamber surface; and
at least one supporting structure connecting the piston top and the piston bottom.

2. A piston according to claim 1, wherein the at least one supporting structure is connected with the inner chamber surface of the piston wall.

3. A piston according to claim 1, wherein the at least one supporting structure protrudes from the piston wall inwardly.

4. A piston according to claim 1, wherein the at least one supporting structure is in the form of a pillar integrated with the piston wall.

5. A piston according to claim 1, wherein the at least one supporting structure and the piston wall are made a single piece of material.

6. A piston according to claim 1, wherein the at least one supporting structure, the piston top and the piston bottom are made in one piece of material.

7. A piston according to claim 1, wherein the at least one supporting structure, the piston top, the piston bottom and the piston wall are made in one piece of material.

8. A piston according to claim 1, wherein the at least one supporting structure protrudes radially towards the center of the hollow supporting piston.

9. A piston according to claim 1, wherein the at least one supporting structure is arranged between the piston wall and a center space in the inner chamber of the piston, the center space forming a clearance space.

10. A piston according to claim 9, wherein the center space of the piston contains a measuring device.

11. A piston according to claim 1, wherein the piston top comprises a top element.

12. A piston according to claim 11, wherein the top element is turnably locked with the piston top.

13. A piston according to claim 12, wherein the top element is part of a thrust bearing.

14. A piston according to claim 1, wherein the at least one supporting structure of the hollow supporting piston comprises at least two supporting elements connecting the piston top and the piston bottom.

15. A piston according to any preceding claim 1, wherein the at least one supporting structure of the hollow supporting piston comprises at least three supporting elements connecting the piston top and the piston bottom.

16. A gyratory crusher comprising a cylindrical, hollow piston having a piston wall; a piston top and a piston bottom, the piston wall including at least one opening leading into an inner chamber of the hollow piston, the piston wall having an outer sliding surface and an inner chamber surface, wherein at least one supporting structure connects the piston top and the piston bottom.

17. A gyratory crusher according to claim 16, further comprising a crusher frame and a crushing head arranged rotatably about a substantially vertical shaft, shaft being rotatably arranged in the frame; and a cylinder-piston assembly including the cylindrical hollow supporting piston that supports the crushing head and the shaft.
